(19) United States
(12) Patent Application Publication
(10) Pub. No.: US 2011/0236559 A1
(43) Pub. Date: Sep. 29, 2011

(54) METHOD OF PRODUCING RUMINANT-EDIBLE FEED PRODUCTS

(75) Inventors: Mark D. Miller, Elk City, OK (US); Timothy A. Murphy, Dodge City, KS (US); Jared Froetschner, Shawnee, KS (US)

(73) Assignee: BYPRODUCT FEED TECHNOLOGIES LLC, Dodge City, KS (US)

(21) Appl. No.: 13/151,097

(22) Filed: Jun. 1, 2011

Related U.S. Application Data
(63) Continuation of application No. 11/764,595, filed on Jun. 18, 2007, now abandoned.

(51) Int. Cl. A23K 1/06; A23K 1/18

(52) U.S. Cl. 426/635

(57) ABSTRACT

Improved methods are provided for the production of consistent quality combined and/or pH-adjusted ruminant feed products using commercial byproducts (e.g., wet distiller's grain products (WDG) and solubles syrup derived from ethanol production) of variable ingredient make-up and density. In a preferred method, continuous streams of WDG and solubles syrup (12, 13) are monitored to determine respective parameters related to the instantaneous mass of the materials therein such as instantaneous density or mass, and such parameters are used to at least in part control the proportions of the WDG and solubles syrup streams (12, 13) used to make a combined product. If desired, these same parameters may be used to adjust the pH of the WDG stream or the combined product.

### CROSS REFERENCE TO RELATED APPLICATION

This is a continuation of application Ser. No. 11/764,595, filed Jun. 18, 2007; such application is incorporated by reference herein.

### BACKGROUND OF THE INVENTION

1. Field of the Invention

The present invention is broadly concerned with methods of preparing pH-adjusted and/or combined ruminant-edible feed products of consistent pH and nutritional qualities, using commercial byproducts (e.g., wet distiller's grain products (WDG)) of variable ingredient make-ups and densities. More particularly, the invention is concerned with such methods wherein commercial byproduct streams are monitored to determine parameters relating to the instantaneous masses of the materials within the byproduct streams, and such parameters are used to at least in part control the proportioning of the streams and/or the amount of pH adjustment required. In this way, nutritionally consistent products can be continuously produced notwithstanding wide variances in the incoming byproduct streams.

2. Description of the Prior Art

Conventional ethanol production plants utilize starch-bearing grains and convert the starch content thereof to glucose using enzymes. The glucose is then fermented to ethanol using yeast, and the ethanol is distilled and recovered, leaving whole stillage. The whole stillage is then centrifuged to yield WDG containing substantial quantities of protein, bran and fat, and thin stillage. The latter may be evaporated to give a condensate product and a concentrated solubles syrup. Typical corn WDG contains approximately 30% crude protein, 10% ether extract, 9-10% crude fiber, and ash (minerals) on a dry matter basis. In some cases the solubles syrup is mixed with the distiller's grain product to yield a combined product, known as wet distiller's grain plus solubles (WDGS). These ethanol plant byproducts provide excellent sources of feed for ruminants, and are commonly used for this purpose.

In conventional practice, WDGS is produced using a screw conveyor system to mix the WDG product and solubles syrup streams without any proportioning of the respective streams. These volumetric screw conveyors work on the principle of metering a constant volumetric quantity of material with each turn of the screw. Therefore, if the density of the materials making up the streams changes, the quantity that the screw system delivers changes as well.

In practice, ethanol plants use a wide variety of cereal grains and combinations thereof as starting materials. In the design of such ethanol plants, there is little or no concern about any changes in density or make-up of the WDG and syrup byproduct streams; indeed, the only aim in such designs is to extract and convert the maximum amount of starch. As a consequence, density fluctuation of the WDG and syrup byproduct streams can lead to significant changes in the actual weight of the WDG that are mixed with the solubles syrup. Moreover, the inherent variability in nutritional content of WDG and syrup make it difficult to prepare consistent and nutritionally balanced feed rations.

These problems are recognized in the art, see, Variation in Composition of Distiller's Wet Grains and Solubles, Robert M. Kaiser, 2004 4-State Dairy Nutrition & Management Conference. In that study, 51 samples of WDGS were evaluated and determined to have variable nutrient compositions. The author also noted that ethanol plant interests were seeking to minimize the variability in WDGS products in order to meet the concerns of the livestock industry. The Shurson et al. presentation entitled “Corn By-Product Diversity and Feeding Value to Non-Ruminants” confirmed that dried distiller's grain solubles (DDGS) had different compositions depending upon the type of grain processing and the source of grain used. The authors suggested that in order to minimize variability in nutrient content, the number of sources for the DDGS be limited, and that evidence of consistent quality and nutrient quantity be demanded from each source.

There is accordingly a real and unresolved need in the art for improved methods for preparing commercial byproduct ruminant feeds which can accommodate variances in the starting byproducts while nonetheless giving high quality feeds of consistent nutritional properties.

### SUMMARY OF THE INVENTION

The present invention overcomes the problems outlined above, and provides improved methods for the preparation of ruminant-edible feed products of consistent quality, using divergent and variable byproducts. Generally, the methods of the invention involve controlled mixing of different, continuous byproduct streams, and/or the incorporation of pH-adjusting agents into one or more such byproduct streams. Proper control and proportioning of the byproduct streams is obtained by measuring one or more parameters related to the instantaneous masses of the materials making up the streams, and using such measured parameters to at least in part control the mixing of the streams, or pH adjustment thereof. As used herein, “instantaneous mass” of a byproduct stream refers to the mass of a predetermined volume of the stream at a given point in time.

In one aspect of the invention, methods are provided for preparing pH-adjusted, ruminantedible feed products. Such methods comprise the steps providing a first stream of a first ruminant-edible material, and measuring a first parameter related to the instantaneous mass of the first material in the first stream. A pH-adjusting agent is added to the first material in order to create a pH-adjusted feed product, and this includes the step of using the measured first parameter to at least in part control the quantity of the pH-adjusting agent added to the first material. The first material may be selected from the group consisting of distiller's grain products, corn gluten, corn steep, whey permeate, and mixtures thereof.

In one preferred method, the first material comprising distiller's grain products recovered as a byproduct of ethanol production, and the measured parameter is the instantaneous mass of these products. The pH-adjusting agent for WDG products is normally a base, preferably NaOH. Also, in the preferred method, the solubles syrup from ethanol production is mixed with the WDG to form WDGS which is then pH-adjusted with base. These products have been found to have particular utility when combined with high digestive efficiency feed grains such as flaked grain, dry rolled grain, ground grain, high moisture, early harvested, ensiled grains, and mixtures thereof. Such products are more fully described in Application for U.S. patent Ser. No. 11/745,566, Filed May 8, 2007, and entitled “Ruminant Feeds Containing pH-Adjusted Edible Byproducts and High Digestive Efficiency Grains,” incorporated by reference herein.

In another aspect of the invention, methods are provided for preparing combined ruminant-edible feed products comprising two or more different byproduct materials. Such methods involve providing a first stream of a first ruminant-edible material, and measuring a first parameter related to the instantaneous mass of the first material in the first stream. In like manner, a second stream of a second ruminant-edible material different from the first material is provided, and the second material is measured to determine a second parameter related to the instantaneous mass of the second material in the second stream. The first and second streams are combined to form a combined ruminant-edible feed product, this involving use of the measured first and second parameters to at least in part control the quantities of the first and second materials combined to form the final feed product. Again, the measured first and second parameters are preferably the instantaneous masses, and the byproduct streams can be selected from a number of sources.

Of course, these different aspects of the invention can be used together, i.e., a given product may be produced using two or more byproduct streams with pH adjustment. A prime example of such a product would be a WDGS product made by the controlled mixing of WDG and solubles syrup byproduct streams, with controlled addition of a pH-adjusting agent.

### BRIEF DESCRIPTION OF THE DRAWINGS

FIG. 1 is a schematic illustration of a preferred apparatus and method in accordance with the invention for the preparation of consistent quality ruminant feed products made from ethanol plant byproducts.

### DETAILED DESCRIPTION OF THE PREFERRED EMBODIMENT

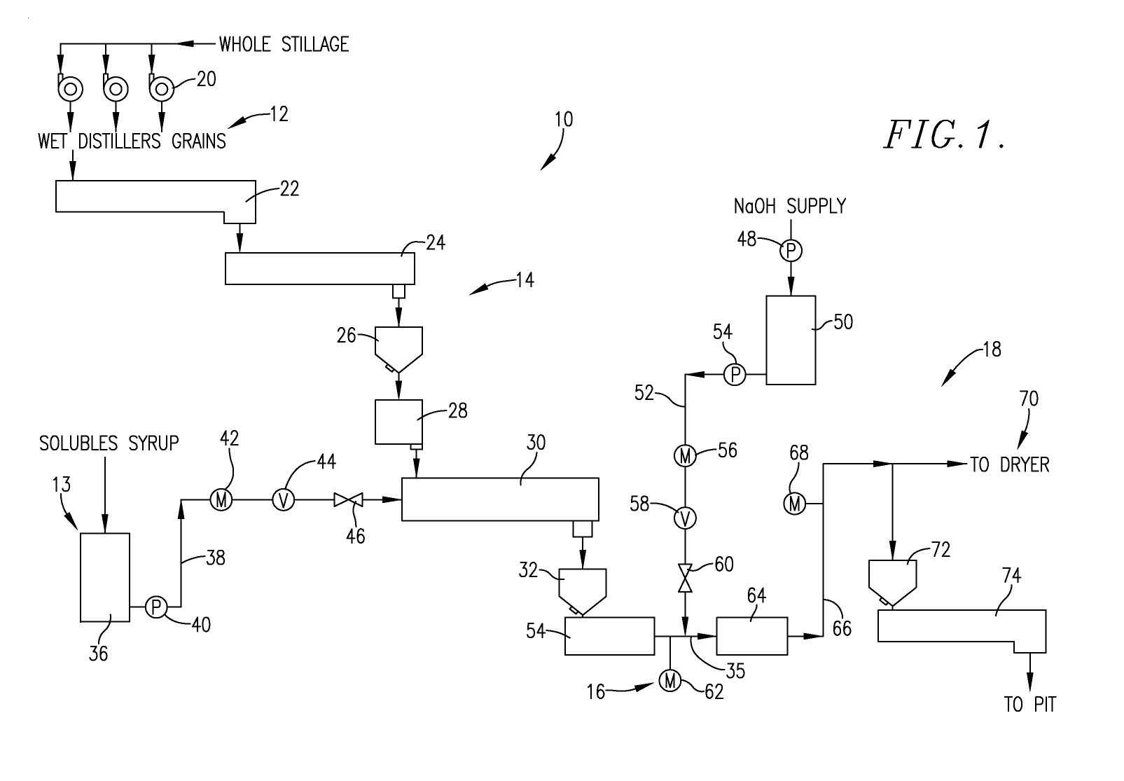

FIG. 1 illustrates an overall apparatus 10 for the continuous production of pH-adjusted distiller's grain products. The apparatus 10 typically forms a part of an ethanol plant (not shown) designed to produce ethanol from grain, while yielding continuous byproduct streams 12 and 13 of WDG and solubles syrup respectively. The operation of ethanol plants in general is well known, and usually involves employing a starting source of starch-bearing grain (e.g., corn, sorghum, wheat, and/or barley, having from about 67-72% by weight starch content). This starting grain is initially processed for size reduction by means of a hammer mill or other type of grinder, whereupon the grain is slurried with water, followed by conventional cooking and enzyme treatment to convert the starch to glucose. Next, the cooked and enzyme-treated product is fermented with yeast to give a fermentation beer. The beer is then distilled, giving recoverable ethanol and whole stillage. The whole stillage is then centrifuged to give the desired WDG product and thin stillage. The latter is then evaporated to give the solubles syrup.

Broadly speaking, the apparatus 10 includes a proportioning assembly 14, a pH-adjustment assembly 16, and a final output assembly 18. A particular feature of the apparatus 10 is the ability to receive the continuous byproduct streams 12, 13 of varying characteristics and densities from the ethanol plant, while nevertheless producing substantially consistent pH-adjusted distiller's grain final products.

In more detail, the continuous WDG byproduct stream 12 used in the methods of the invention is typically derived from the whole stillage produced in the ethanol plant, the latter being treated in cyclones 20 or other similar dewatering equipment so as to produce the desired byproduct stream12. This byproduct stream 12 is directed to a transfer conveyor 22, which delivers the byproduct stream to a screw conveyor 24. The screw conveyor 24 is coupled with a flow modulation surge tank 26. The underflow stream from tank 26 is directed to a solids mass flow meter 28, which is preferably either a Centri-Flow meter or weigh belt feeder, both of which are density-independent. The function of the flow meter 28 is to measure the instantaneous weight of the product passing therethrough, and the meter may be operated continuously or intermittently (e.g., every 5 or 10 seconds). The weighed product stream is then delivered to a mixing conveyor 30 (preferably a double shaft unit), which feeds a pump flow modulation surge tank 32 equipped with a flow sensor. The tank 32 is operatively coupled with a positive displacement pump 34, having an output line 35. The pump 34 operates to create a continuous stream using a preset, adjustable viscosity value, such as the viscosity of peanut butter, to maintain a consistent, positive displacement output stream.

In preferred forms, the assembly 14 also includes apparatus for optional delivery of the solubles syrup stream 13 to mixing conveyor 30, so that the syrup stream 13 is thoroughly mixed with the distiller's grain product stream therein. Such syrup delivery apparatus includes a syrup staging tank 36 having an output line 38 leading to mixing conveyor 30. A transfer pump 40, liquid mass flow meter 42, flow control valve 44, and two-way on/off valve 46 are interposed in output line 38 as shown. The flow meter 42 is preferably a coriolis meter, and serves to accommodate density, viscosity and temperature fluctuations in the syrup stream 13. As in the case of meter 28, the meter 42 may be operated either continuously or intermittently.

The pH-adjustment assembly 16 includes a supply of acid or base as necessary, and is typically 50% NaOH for an ethanol plant. A pump 48 is used to deliver the NaOH to a nurse tank 50 and a delivery line 52 extends from nurse tank 50 to output line 35. A transfer pump 54, liquid mass flow meter 56 (preferably a coriolis meter), flow control valve 58, and two-way on/off valve 60 are interposed within delivery line 52. The overall assembly 16 further includes a pH meter 62, operatively coupled with output line 35, upstream of delivery line 52, as well as an in-line static mixer 64 equipped with an output line 66. The pH meter 62 monitors the pH of the material stream exiting pump 34 via output line 35, and mixer 64 assures that added NaOH is thoroughly and substantially homogeneously mixed with the distiller's grain product stream.

The final output assembly 18 includes a final pH meter 68 and may optionally direct the product stream from mixer 64 to a dryer 70 for production of pH-adjusted dried distiller's grain product with or without solubles (DDG or DDGS), or to a WDG product recovery, including a surge tank 72, and a downstream transfer conveyor 74, leading to pit storage.

The overall apparatus 10 is advantageously controlled by a digital controller assembly, such as one or more operably interconnected PLCs (not shown). In preferred practice, the inputs to the digital controller assembly are a start system input from the ethanol plant, and from the mass flow meters 28 and 42, the sensor of surge tank 32, pH meter 62, flow meter 56, and final pH meter 68. The controller assembly outputs are directed to flow meter 28, syrup pump 40, syrup flow control valve 44, pump 34, NaOH transfer pump 54, flow control valve 58, and to the loop logic of the digital controller assembly, in order to control the operation of apparatus 10.

In practice, the ethanol plant is operated in its normal manner, producing the byproduct stream 12 of WDG product, and the byproduct stream 13 of solubles syrup. As explained previously, these byproduct streams can vary significantly in their respective ingredient make-up, density, and temperature values. Notwithstanding these variances, the apparatus 10 is designed to deliver substantially consistent outputs ofpH-adjusted distiller's grain products, either wet, dry, or mixtures thereof.

During continuous operation of the apparatus 10, the byproduct stream 12 of distiller's grain product is continuously or intermittently weighed with mass flow meter 28, and the solubles syrup stream 13 is also continuously or intermittently weighed with liquid flow meter 42. These weigh measurements represent the instantaneous masses of the WDG product and solubles syrup, respectively. The solubles syrup pump 40 is effectively slaved to the mass flow meter 28 using the digital controller assembly, in order to ensure a consistent weight ratio of WDG product to solubles syrup. In like manner, the digital controller assembly monitors the pH of the combined WDGS product (or only that of the WDG product alone, if solubles are not added) in output line 35 using pH meter 62, and this data is used to control pump 54 and valve 58 so as to initiate delivery of NaOH to output line 35 for mixing in static mixer 64. The pH of the product stream discharged from mixer 64 is measured using final pH meter 68, and this data is sent to the digital controller assembly as part of a control feedback loop, which in turn adjusts and modulates the flow of the NaOH via control of pump 54 and valve 58 to achieve the desired pH level in the product stream.

While in the preferred apparatus 10 use is made of density-independent mass flow meters, the invention is not so limited. That is, it would also be possible to use density or specific gravity measurement devices in lieu of the mass flow meters. However, these would entail additional levels of apparatus and complexity, and are thus not deemed optimum. Generally speaking, it is only required that measurements be made of one or more parameters of the WDG and solubles syrup making up the streams 12, 13 which are related to the instantaneous mass of these materials during the continuous operation of the apparatus 10.

As noted previously, the constituents and densities of WDG and solubles syrup byproducts from a typical ethanol plant can vary widely. Unless these variances are taken into account in the production of final rumen-edible products, corresponding significant and undesirable variations are found in such final products. Table 1 below illustrates the impact of failing to adjust the feed rates of a variable density starting material, in the use of a conventional constant volumetric feeding screw system. In this example, a density of 48 lbs./bu. is taken to be a standard density. As can be seen, if the density of the starting material changes by 8 lbs./bu., the amount of product delivered after 1000 revolutions of the feeding screw decreases by 16.7%.

TABLE 1

| Material | Vol. Feeder | | | Deviation from |
|---|---|---|---|---|
| Density, | Constant, | Bushels/ | Weight/ | Standard |
| lbs/bu | bu/rev | 1000 rev, lb | 1000 rev, lb | Calibration, % |
| 50 | 0.21 | 210 | 10500 | 4.2% |
| 49 | 0.21 | 210 | 10290 | 2.1% |
| 48 | 0.21 | 210 | 10080 | — |
| 47 | 0.21 | 210 | 9870 | 2.1% |
| 46 | 0.21 | 210 | 9660 | −4.2% |
| 45 | 0.21 | 210 | 9450 | −6.3% |
| 44 | 0.21 | 210 | 9240 | −8.3% |
| 43 | 0.21 | 210 | 9030 | −10.4% |
| 42 | 0.21 | 210 | 8820 | −12.5% |
| 41 | 0.21 | 210 | 8610 | −14.6% |
| 40 | 0.21 | 210 | 8400 | −16.7% |

In contrast, Table 2 illustrates the effects of measuring instantaneous density changes in the starting material and adjusting the output of the feeding screw (such as by use of a variable frequency drive) to achieve a constant delivered weight after 1000 revolutions of the feeding screw. As can be seen, if instantaneous densities are monitored on a consistent basis, such volumetric feeders can be adjusted to deliver a consistent product output.

TABLE 2

| Material | Vol. Feeder | | | Deviation from |
|---|---|---|---|---|
| Density, | Constant, | Bushels/ | Weight/ | Standard |
| lbs/bu | bu/rev | 1000 rev | 1000 rev, lb | Calibration, % |
| 50 | 0.202 | 202 | 10100 | 0.2% |
| 49 | 0.206 | 206 | 10094 | 0.1% |
| 48 | 0.21 | 210 | 10080 | — |
| 47 | 0.215 | 215 | 10105 | 0.2% |
| 46 | 0.219 | 219 | 10074 | −0.1% |
| 45 | 0.224 | 224 | 10080 | 0.0% |
| 44 | 0.229 | 229 | 10076 | 0.0% |
| 43 | 0.234 | 234 | 10062 | −0.2% |
| 42 | 0.24 | 240 | 10080 | 0.0% |
| 41 | 0.246 | 246 | 10086 | 0.1% |
| 40 | 0.252 | 252 | 10080 | 0.0% |

In the preferred method of the invention, WDG and solubles syrup are mixed to give WDGS, followed by pH adjustment. These ethanol plant byproducts can vary widely in terms of densities, and if this factor is ignored, significant changes in the weight ratio of WDG product and solubles syrup can result. This is a problem, inasmuch as the final mixed and pH-adjusted products will necessarily have divergent nutritional properties. Table 3 below exemplifies a system which fails to adjust the feeding rate of WDG products when variable density WDG byproducts are encountered.

TABLE 3

| DDG | | Screw | | | Syrup | | |
|---|---|---|---|---|---|---|---|
| Density, | Bushels/ | Speed, | Bushels/ | Weight, | Rate, | DDG | Syrup |
| lbs/bu | rev | rpm | min | lbs/min | lbs/min | Ratio | Ratio |
| 50 | 0.21 | 10 | 2.100 | 105.00 | 72.28 | 59.23% | 40.77% |
| 49 | 0.21 | 10 | 2.100 | 102.90 | 72.28 | 58.74% | 41.26% |
| 48 | 0.21 | 10 | 2.100 | 100.80 | 72.28 | 58.24% | 41.76% |
| 47 | 0.21 | 10 | 2.100 | 98.70 | 72.28 | 57.73% | 42.27% |
| 46 | 0.21 | 10 | 2.100 | 96.60 | 72.28 | 57.20% | 42.80% |
| 45 | 0.21 | 10 | 2.100 | 94.50 | 72.28 | 56.66% | 43.34% |
| 44 | 0.21 | 10 | 2.100 | 92.40 | 72.28 | 56.11% | 43.89% |
| 43 | 0.21 | 10 | 2.100 | 90.30 | 72.28 | 55.54% | 44.46% |
| 42 | 0.21 | 10 | 2.100 | 88.20 | 72.28 | 54.96% | 45.04% |
| 41 | 0.21 | 10 | 2.100 | 86.10 | 72.28 | 54.36% | 45.64% |
| 40 | 0.21 | 10 | 2.100 | 84.00 | 72.28 | 53.75% | 46.25% |

Table 4 depicts the advantages realized by measuring the density of the incoming WDG products and correspondingly changing the feeding rate of the products. As can be seen, the ratio of WDG:solubles syrup is held essentially constant, resulting in a more uniform feed product.

TABLE 4

| DDG | | Screw | | | Syrup | | |
|---|---|---|---|---|---|---|---|
| Density, | Bushels/ | Speed, | Bushels/ | Weight, | Rate, | DDG | Syrup |
| lbs/bu | rev | rpm | min | lbs/min | lbs/min | Ratio | Ratio |
| 50 | 0.202 | 10 | 2.020 | 101.00 | 72.28 | 58.29% | 41.71% |
| 49 | 0.206 | 10 | 2.060 | 100.94 | 72.28 | 58.27% | 41.73% |
| 48 | 0.21 | 10 | 2.100 | 100.80 | 72.28 | 58.24% | 41.76% |
| 47 | 0.215 | 10 | 2.150 | 101.05 | 72.28 | 58.30% | 41.70% |
| 46 | 0.219 | 10 | 2.190 | 100.74 | 72.28 | 58.22% | 41.78% |
| 45 | 0.224 | 10 | 2.240 | 100.80 | 72.28 | 58.24% | 41.76% |
| 44 | 0.229 | 10 | 2.290 | 100.76 | 72.28 | 58.23% | 41.77% |
| 43 | 0.234 | 10 | 2.340 | 100.62 | 72.28 | 58.19% | 41.81% |
| 42 | 0.24 | 10 | 2.400 | 100.80 | 72.28 | 58.24% | 41.76% |
| 41 | 0.246 | 10 | 2.460 | 100.86 | 72.28 | 58.25% | 41.75% |
| 40 | 0.252 | 10 | 2.520 | 100.80 | 72.28 | 58.24% | 41.76% |

While the invention has been exemplified in the context ofusing ethanol plant byproducts to produce combined and/or pH-adjusted ruminant feeds, the invention is not so limited. Rather, the invention embraces the use of a multitude of possible other commercial byproducts, such as corn gluten, corn steep, whey permeate, and mixtures thereof. In addition, the invention contemplates mixtures of different byproducts from different sources, e.g., a mixture of WDG and whey permeate. As can be appreciated, the principles of the invention allow production of many such combined products of consistent quality.

We claim:

1. A method of preparing a pH-adjusted ruminant-edible feed product, comprising the steps of:
providing a continuous first stream of material comprising a distiller's grain product derived from a whole stillage byproduct of an ethanol plant after ethanol distillation, said product having variable constituents and densities;
continuously or intermittently measuring a first parameter related to the instantaneous mass of said first material in said continuous first stream, said first parameter selected from the group consisting of the mass, density, and specific gravity of the material in said continuous first stream; and
adding a pH-adjusting agent comprising base to said first stream in order to create a pH-adjusted feed product,
said adding step including the step of using said continuously or intermittently measured first parameter to at least in part control the quantity of said agent added to said first stream, in order to generate a continuous substantially consistent output stream.

2. The method of claim 1, said first parameter being the instantaneous density of said first material in said first stream.

3. The method of claim 1, said first parameter being the instantaneous mass of said first material in said first stream.

4. The method of claim 1, said base comprising NaOH.

5. The method of claim 1, including the steps of:
providing a continuous second stream of a second ruminant-edible material;
mixing said continuous first and second streams prior to or after said adding step to create a combined feed product.

6. The method of claim 5, including the steps of measuring a second parameter related to the instantaneous mass of said second material in said second stream, and using said second parameter to at least in part control the quantities of said first and second materials in said combined feed product.

7. The method of claim 5, said second material comprising a solubles syrup, said solubles syrup being a byproduct of ethanol production.

8. The method of claim 6, said second parameter being the instantaneous density of said second material in said second stream.

9. The method of claim 6, said second parameter being the instantaneous mass of said second material in said second stream.

10. The method of claim 1, said distiller's grain product prepared by dewatering said whole stillage.
